(19) United States
(12) Patent Application Publication
(10) Pub. No.: US 2026/0204451 A1
(43) Pub. Date: Jul. 16, 2026

(54) ION SURFACE TRAP

(71) Applicant: PHYSIKALISCH-TECHNISCHE BUNDESANSTALT BRAUNSCHWEIG UND BERLIN, Braunschweig (DE)

(72) Inventor: Sebastian RAUPACH, Braunschweig (DE)

(21) Appl. No.: 19/133,443

(22) PCT Filed: Dec. 1, 2023
(86) PCT No.: PCT/EP2023/083873

§ 371 Date: May 28, 2025

(30) Foreign Application Priority Data
Dec. 7, 2022 (DE) 10 2022 132 526.1

(51) Int. Cl. G21K 1/20

(52) U.S. Cl. CPC G21K 1/20

(57) ABSTRACT

The invention relates to an ion surface trap (10) with an electrode pair (12) that comprises a first trap electrode (14.1) and a second trap electrode (14.2) and is configured to form a trap volume for at least one ion when an electrical AC voltage is applied, and a sensor element (18) for detecting photons (20) emitted by at least one ion, wherein the sensor element (18) comprises a superconductor layer and forms the second trap electrode (14.2) and does not have a superconductor layer-separating layer-superconductor layer structure.

The invention relates to an ion surface trap with (a) an electrode pair that comprises a first trap electrode and a second trap electrode and that is configured to form a trap volume for at least one ion when an electrical AC voltage is applied, (b) a sensor element for detecting photons emitted by at least one ion. According to a second aspect, the invention relates to a method for operating such an ion surface trap.

Ion surface traps are used to hold one, two or multiple (i.e. 3, 4, 5, . . . N) ions in a given space. For example, an ion surface trap is used in an atomic clock or a quantum computer. An atomic clock and/or a quantum computer with an ion surface trap according to invention are likewise subjects of this invention.

In order to determine the calculation result, the quantum state of the ion must be read. To this end, the fluorescence of individual ions has to be detected. The larger the photodetector used to detect the fluorescence, the less space there is available for the trap electrodes via which, for example, an alternating electric field is applied in order to build up the trap potential for the ion.

Ion surface traps are often implemented on a chip. Special sensors are arranged on the chip to detect light emitted by the ion, as described, for example, in the article “State Readout of a Trapped Ion Qubit Using a Trap-Integrated Superconducting Photon Detector” by Todaro et al., Phys. Rev. Lett. (2021).

An ion surface trap according to the preamble is known from the article “State Readout of a Trapped Ion Qubit Using a Trap-Integrated Superconducting Photon Detector” by Todaro et al., Physical Review Letters, Vol. 126 2021 No 1, with which qubits can be read out. There are no optical elements between the ion and the detector so that the fluorescence of the ions can be used to measure the quantum efficiency of the detector as well as its dependency on the angle of incidence and incidence polarisation.

The article “Uv-sensitive superconducting nanowire single photon detectors for integration in an ion trap” by Slichter et al, in Optics Express, Vol. 25 2017 No. 8 p. 8705-8720 describes a single-photon detector that is used in a Paul trap with planar radio frequency electrodes.

The paper “Fluorescence detection of a trapped ion with monolithically integrated single-photon-counting avalanche diode” by Setzer et al, in arXiv: 2105.01235v2 [quant-ph], from Jul. 7, 2021 (S 1-6) DOI: 10.48550/arXiv.2105.01235 presents an ion surface trap according to the preamble for detecting fluorescent light of an ion trapped in a trap using single-photon avalanche photodiodes, which are integrated on a chip along with a surface ion trap.

DE 10 2019 114 842 A1 describes an ion trap for holding at least one ion in a space defined by a ponderomotive potential. Electrodes of an electrode structure arranged around the space are controlled in such a way that ions in the ion trap are detected by a laser beam.

DE 10 2018 121 942 B3 discloses an ion trap comprising two electrodes that are configured to generate an electrical field which includes an attractive ponderomotive potential in at least one area. An electrical resonator supplies electrodes of the ion trap with an AC voltage and comprises a resonant circuit arranged within the vacuum chamber. This allows the AC voltage field of the ion trap to be calibrated more easily.

U.S. Pat. No. 6,710,334 B1 describes a quadruple ion trap mass spectrometer for large molecules through the use of cryogenic particle detectors as molecule detectors. Cryogenic particle detectors have a mass-independent detection efficiency and show no reduction in detection efficiency as molecule mass increases when compared with ionizing detectors used in conventional quadrupole ion trap mass spectrometers.

In U.S. Pat. No. 5,994,694 contains an ultra-high mass time-of-flight mass spectrometer that uses a cryogenic particle detector as an ion detector. The cryogenic detector improves performance and sensitivity. A cryogenically cooled Nb—Al₂O₃—Nb superconductor-insulator-superconductor (SIS) tunnel junction detector is used that works at 1.3 K. The STJ detector has the capacity to distinguish between charges. Given that the cryogenic STJ detector responds to ion energy and is not reliant on the generation of secondary electrons, it is able to recognize large molecular ions with a speed-independent efficiency of almost 100%.

The article “Quasiparticle trapping and the quasiparticle multiplier” by N. E. Boot, in Applied Physics Letters, Vol. 50 1987 No. 5, p. 293-295, ISSN 0003-6951 (P) describes the detection of phonons, electromagnetic radiation and nuclear particles by means of superconducting tunnel contacts.

WO 2015/128 438 A1 describes a system with a cryostat and a surface electrode trap on a silicon substrate. On its front side are planar electrodes, which are configured in such a way that they generate a capture potential. A first high-frequency electrode extends parallel to the front side of the substrate; a DC electrode extends parallel to the front side, abuts the first high-frequency electrode and is electrically insulated from said high-frequency electrode. The surface electrode trap is arranged in the cryostat, which cools the surface electrode trap to a maximum of 150 K.

DE 10 2021 124 396 A1 describes an ion surface trap with an electrode pair that comprises a first trap electrode and a second trap electrode and forms a trap volume for an ion. The ion surface trap also has two DC voltage electrodes for closing off the trap volume and an energy-sensitive superconductor sensor for detecting photons emitted by the ion, which has a superconductor layer-separating layer-superconductor layer structure. The first superconductor layer forms the first trap electrode.

It has proven to be very difficult to detect radiation, for example fluorescent radiation, emitted by the ion.

The invention aims to improve the detection of photons emitted by the trapped ion.

The invention solves the problem by way of an ion surface trap according to the preamble in which the sensor element comprises a superconductor layer and which forms a trap electrode. In particular, the superconductor layer forms the trap electrode. Preferably, the sensor element does not have a superconductor layer-separating layer-superconductor layer structure.

The invention also solves the problem by way of a method featuring the steps (i) introducing an ion into an ion surface trap according to the invention, (ii) applying a trap voltage to the first trap electrode and the sensor element so that the ion remains trapped in the ion surface trap, and (iii) detecting at least one photon that has been emitted by the ion by means of the sensor element.

The advantage of the invention is that radiation emitted by the ion only has to travel a short distance to be detected by the sensor and, as provided for according to one preferred embodiment, does not pass through any optical elements, such as optical windows, lenses, glass fibers etc. The probability of being absorbed on the path from ion to sensor is therefore low.

Due to the spatial proximity of the sensor to the trapped ion, the sensor can also detect photons in a comparatively wide solid angle range. The structure according to the invention also enables the sensor to have a comparatively large spatial expansion, thereby covering an even greater solid angle range than if it were restricted to the space between the electrodes.

It is also convenient that the invention generally allows for a greater integration density. Alternatively or additionally, this results in simplified production, especially in series production.

The invention is based in particular on the idea of eliminating the separation of sensor and trap electrode known from the prior art. In other words, at least one trap electrode forms a part of the structure that serves to detect individual photons.

The advantage of the invention is that the function of the trap electrode and that of the sensor is combined. This allows for an especially simple structure. The superconductor layer is preferably designed in such a way that when a photon with a specified minimum energy is absorbed, the superconductivity initially collapses locally and the electrical resistance increases locally as a result. This in turn leads to the critical current density being exceeded in the vicinity of the photon's point of impact, so that the superconductivity also collapses. As a result, the area in which the superconductivity collapses continues to expand. This causes a measurable increase in the electrical resistance of the superconductor layer. This increase occurs from a very good approximation of 0 ohms to a significantly higher value of usually more than 1 kiloohm.

Within the scope of the present description, the sensor element is understood particularly to mean any structure of the ion surface trap by means of which a photon with a predetermined minimum energy can be detected if the photon impacts the sensor element. The minimum energy is preferably at least 0.5 eV, particularly 0.8 eV.

A superconductor layer is understood to mean a layer of material which becomes superconductive at a temperature below a transition temperature. Preferably, the superconductor layer is constructed from a high-temperature superconductor. It is beneficial if the high-temperature superconductor has a transition temperature above 77 Kelvin.

However, it is also possible that the superconductor material is not a high-temperature superconductor. For example, the superconductor material is NbN, Nb, NbTiN, McSi or WSi.

It is beneficial if a superconductor layer thickness of the superconductor layer lies between 5 nm and 500 nm.

The electrode pair is understood to mean the unit composed of the first trap electrode and the second trap electrode. It is possible, but not essential, for at least one of the trap electrodes to be made up of 2, 3 or more partial electrodes. It is also possible, but not essential, for individual partial electrodes to be electrically insulated against each other. Alternatively, the individual partial electrodes are in electrical contact with each other so that they are at the same electric potential.

When the trap voltage is applied to the electrode pair, a trap volume forms. The trap volume is the space that the ion cannot leave.

According to one preferred embodiment, the ion surface trap has a current source that is configured to automatically apply a measuring current to the superconductor layer, wherein the measuring current is selected to be so large that an impact of a photon with a predetermined minimum energy at a point of impact on the superconductor layer causes a conduction power in a vicinity of the point of impact, said conduction power spreading across the entire cross-section of the superconductor layer, in particular across the entire cross-section of the superconductor layer at the point of impact.

In particular, the power source is connected to a trap electrode in such a way that the basic electrical potential of the current source corresponds to the potential of the trap electrode. In particular, the basic potential of the current source does not correspond to the basic potential of the ion trap.

Preferably, the ion surface trap has a trap voltage source that is connected to the first trap electrode and the sensor element for the purpose of applying a trap voltage. The trap voltage is therefore between the basic potential of the voltage source on the one hand and the first trap electrode on the other. The trap voltage source may be designed to emit a DC voltage, an AC voltage or a DC and AC voltage. The trap voltage is preferably at least 10 V and/or at most 300 V.

The potential of one of the trap electrodes can be connected to earth. Preferably, however, both trap electrodes are at the same potential. The sum of the two (signed) potentials is then preferably 0 V.

The ion surface trap preferably has at least two DC voltage electrodes that are arranged to generate an electrical field by means of which an ion position of the ion relative to the ion surface trap can be altered. Preferably, one of the DC voltage electrodes is at the same potential as one of the two trap electrodes.

DC voltage electrodes are understood particularly to mean electrodes by means of which a static electric confinement field can be generated. The confinement field is preferably configured in such a way that the trap volume is closed in all spatial directions.

The ion surface trap preferably has an ohmmeter for measuring a change in the electrical resistance of the superconductor layer. If the electrical resistance of the superconductor layer, it can be concluded that a photon with at least the predetermined minimum energy has impacted. The voltage source may form part of the ohmmeter. The change in resistance is usually from a good approximation of 0Ω (if the superconductor layer is superconducting) to 1 kΩ or more (if the superconductor layer is normally conducting).

The superconductor layer is preferably designed in such a way that it has a resistance of at least 50 ohms in the normally conducting state at 1 Kelvin below the transition temperature of the superconductor material from which the superconductor layer is constructed.

The ion surface trap preferably has a substrate on which the trap electrodes and, where applicable, the AC voltage electrodes are mounted. The substrate is preferably not conductive. The substrate is preferably a semi-conductor, quartz glass or corundum. Alternatively, the substrate may be a silicon coated in an insulator, for example. Other substrate materials are possible.

It should be noted that a structure of the ion surface trap, such as the first trap electrode, can be mounted directly on the substrate. However, this is not essential. Rather, it is also possible that one of the named structures is mounted on another of the named structures, which for its part is indirectly or directly connected to the substrate. Preferably, the first trap electrode, the second trap electrode and the superconductor layer form a single-piece unit with the substrate.

Preferably, the superconductor layer is electrically insulated and potential-separated from the first trap electrode.

According to one preferred embodiment, the ion surface trap has an ion introduction device for introducing an ion into a trap volume of the ion surface trap. It is also practical if the ion surface trap has an evaluation unit that it configured to automatically carry out a method comprising the steps (i) controlling the ion introduction device to that an ion is introduced into the ion surface trap, (ii) controlling the trap voltage source for applying the trap voltage between the first trap electrode and the sensor element such that the ion remains trapped in the ion surface trap, and (iii) detecting at least one photon emitted by the ion by means of the sensor element using the change in resistance of the superconductor layer.

Preferably, the ion introduction device has an evaporator for generating a gas composed of particles of a chemically pure substance, such as a metal, especially an alkaline metal, and a photon-ionizer for ionizing metal atoms, especially alkaline metal atoms, so that ions are created. The photon-ionizer preferably has an electrode arrangement and a control unit that is connected to the electrode arrangement such that the generated ions can be introduced individually into the ion surface trap.

It is beneficial if the ion surface trap comprises an evaluation unit that is connected to the ohmmeter. The evaluation unit is preferably configured to perform a method according to the invention.

Preferably, the ion surface trap comprises a discharge resistor element which is connected in parallel to the superconductor layer and whose ohmic discharge resistance is lower than the ohmic superconductor layer resistance of the superconductor layer when the superconductor layer is normally conducting. The ohmic discharge resistance is preferably less than half, in particular less than one fifth, especially preferably less than one tenth, of the ohmic superconductor layer resistance. When the superconductor layer is in the normally conducting state, it heats up due to the electrical measuring current flowing through it. The discharge resistor element causes such a large proportion of the measuring current to flow through the discharge resistor that sufficiently little heat is dissipated by the remaining current in the superconductor layer, which has become completely or partially normally conducting, so that it becomes superconducting again after a certain relaxation time. The relaxation time is preferably at most 100 nanoseconds.

It is beneficial if the ion surface trap is implemented on a chip. In particular, the electrode pair, the DC voltage electrodes and the sensor element are integral components of the chip. These structures are produced in particular by successively depositing different layers on top of each other and/or etching out parts of the layered structure.

If several ions are to be caught in the ion surface trap, which represents a preferred embodiment, it is advantageous if it is possible to determine, with at least sufficiently high probability, which ion a photon detected by the sensor element originates from.

It is therefore beneficial if at least the superconductor layer comprises at least two spatially separate detection sections that are electrically insulated against each other.

The invention also includes an ion surface trap system with (a) an ion surface trap according to the invention and (b) a cooling device, especially a cryostat, for cooling the ion surface trap.

The method preferably comprises the steps (i) vaporizing a pure substance so that it is available in form of a gas, (ii) photon-ionizing the gaseous pure substance and (iii) moving at least one ion of the gaseous pure substance into a trap volume of the ion surface trap.

In the following, the invention will be explained in more detail with the aid of the accompanying drawings. They show:

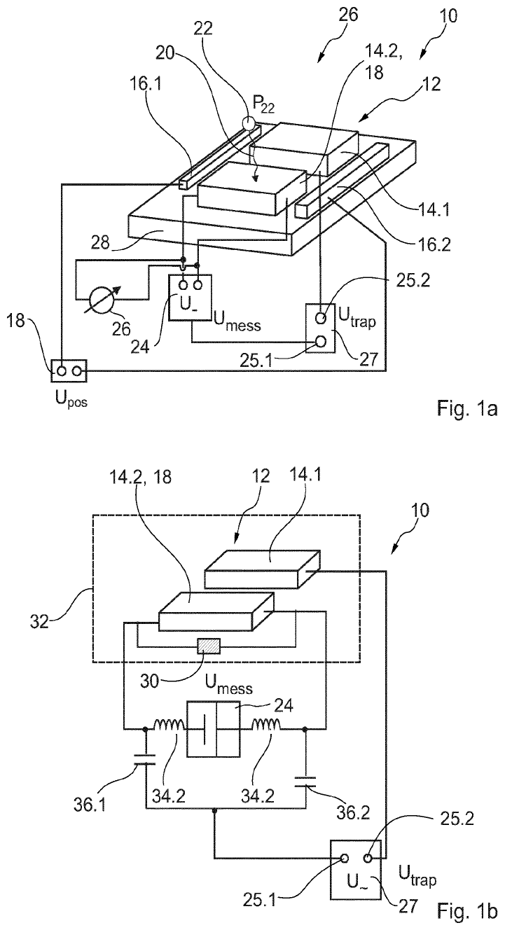

FIG. 1a a schematic view of an ion surface trap according to a first embodiment and

FIG. 1b a schematic view of an ion surface trap according to a second embodiment.

FIG. 1 schematically depicts an ion surface trap 10 according to the invention that has an electrode pair 12. The electrode pair 12 comprises a first trap electrode 14.1 and a second trap electrode 14.2.

The first trap electrode 14.1 is formed, for example, by a metallization, particularly one made out of gold. The second trap electrode 14.2 is composed of a superconductor, for example made of niobium, tantalum or a high-temperature superconductor, such as yttrium barium copper oxide.

The ion surface trap 10 also has a first DC voltage electrode 16.1 and a second DC voltage electrode 16.2 which are connected to a positioning voltage source 17, which emits a positioning voltage Uₚₒₛ.

The second trap electrode 14.2 forms a sensor element 18 which has an ohmic superconductor layer resistance R₁₈ in the normally conducting state. The sensor element 18 can be used to detect a schematically depicted photon 20, which has been emitted by a likewise schematically depicted ion 22. The ion 22 is positioned in a predetermined position P₂₂ by means of the trap voltage Uₜᵣₐₚ. It is possible that the trap electrode 14.2 comprises further, non-superconducting sections. In this case, only the superconducting part of the trap electrode 14.2 is the sensor element 18.

The ion surface trap 10 comprises a current source 24 that is connected to opposite ends of the second trap electrode 14.2 and causes a measuring current Iₘₑₛₛ through the second trap electrode 14.2. An associated measuring voltage Uₘₑₛₛ is close to zero if the second trap electrode is superconducting and jumps to a higher value if the superconductivity breaks down.

A change in the electrical resistance of the second trap electrode 14.2 is measured by means of an ohmmeter 26, which in the present case can be designed as a voltmeter.

The current source 24 is connected to a first pole 25.1 of a trap voltage source 27 such that the reference potential of the current source 24 corresponds to the potential of said pole 25.1. For example, the potential is earth.

The two trap electrodes 14.1, 14.2 are arranged on a substrate 28, for example made of corundum.

FIG. 1b shows a second simplified schematic view of an ion surface trap 10 according to the invention according to a second embodiment. A discharge resistor element 30 can be seen.

A cooling device 32 in the form of a cryostat is schematically depicted which brings at least the electrode pair 12 and the sensor element 18 to an operating temperature T_{b}, which is below a transition temperature T_{Sprung} of the superconductor material.

The two poles of the current source 24 are connected to an inductance 34.1, 34.2, which act as a low-pass filter. This prevents the high-frequency part of the trap voltage Uₜᵣₐₚ from reducing the stability of the measuring voltage Uₘₑₛₛ.

The potential of the trap electrodes 14.1, 14.2 is separated from the potential of the trap voltage source 27 by two condensers 36.1, 36.2.

### REFERENCE LIST

10 ion surface trap
12 electrode pair
14.1 first trap electrode
14.2 second trap electrode
16.1 first DC voltage electrode
16.2 second DC voltage electrode
17 positioning voltage source
18 sensor element
20 photon
22 ion
24 current source
25 pole
26 ohmmeter
27 trap voltage source
28 substrate
30 discharge resistor element
32 cooling device
34 inductance
36 condenser
R₁₈ superconductor layer resistance
R₃₀ ohmic discharge resistance
Uₚₒₛ positioning voltage
Uₘₑₛₛ measuring voltage
Iₘₑₛₛ measuring current

1. An ion surface trap, comprising:
(a) an electrode pair that comprises a first trap electrode and a second trap electrode, wherein the electrode pair is configured to form a trap volume for at least one ion when an electrical alternating current voltage is applied,
(b) a sensor element for detecting photons emitted by the at least one ion, and
(c) wherein the sensor element comprises a superconductor layer and forms the second trap electrode of the electrode pair, and wherein the sensor element and does not have a superconductor layer-separating layer-superconductor layer structure.

2. The ion surface trap according to claim 1, further comprising a current source configured to automatically
(i) apply a measuring current (Iₘₑₛₛ) to the superconductor layer that is selected to be so large that an impact of a photon with a predetermined minimum energy at a point of impact on the superconductor layer causes a normal conduction in a vicinity of the point of impact that spreads across an entire cross-section of the superconductor layer, and
(ii) detect a change in one of a plurality of variables that characterize the measuring current (Iₘₑₛₛ).

3. The ion surface trap according to claim 1 further comprising
a trap voltage source connected to the first trap electrode and the sensor element for applying a trap voltage (Uₜᵣₐₚ).

4. The ion surface trap according to claim 1 further comprising
at least two direct current (DC) voltage electrodes arranged to generate an electrical field by which an ion position of the ion relative to the ion surface trap is alterable.

5. The ion surface trap according to claim 1 further comprising
an ohmmeter for measuring a change in resistance of the superconductor layer.

6. The ion surface trap according to claim 1 further comprising
(a) a substrate on which the first trap electrode and the superconductor layer are mounted,
(b) wherein the superconductor layer is electrically insulated and potential-separated from the first trap electrode.

7. The ion surface trap according to claim 1 further comprising
(a) an ion introduction device for introducing an ion into a trap range of the ion surface trap, and
(b) an evaluation unit configured to automatically carry out a method comprising
(i) controlling the ion introduction device such that an ion is introduced into the ion surface trap,
(ii) controlling a trap voltage source for applying a trap voltage between the first trap electrode and the sensor element so that the at least one ion remains trapped in the ion surface trap (10), and
(iii) detecting at least one photon emitted by the at least one ion by the sensor element.

6. The ion surface trap according to claim 1 further comprising a discharge resistor element connected in parallel to the superconductor layer, wherein the discharge resistor element has an ohmic discharge resistance (R₃₀) lower than an ohmic superconductor layer resistance (R₁₈) of the superconductor layer when the superconductor layer is normally conducting.

7. The ion surface trap according to claim 1 further comprising a current source
(a) connected to the first trap electrode and the second trap electrode by one inductance each, and/or
(b) connected to a trap voltage source by via at least one capacity.

8. A method for operating an ion surface trap according to claim 1, comprising:
(i) introducing an ion into the ion surface trap,
(ii) applying a trap voltage to the first trap electrode and the sensor element so that the ion remains trapped in the ion surface trap, and
(iii) detecting at least one photon emitted by the ion with the sensor element.

9. The method according to claim 10, further comprising
(i) vaporizing a pure substance so that it is available as a gas,
(ii) photon-ionizing the gas, and
(iii) moving at least one ion of the gas into a trap volume of the ion surface trap.
